(19) United States
(12) Patent Application Publication
(10) Pub. No.: US 2023/0197390 A1
(43) Pub. Date: Jun. 22, 2023

(54) CIRCUIT BREAKER

(71) Applicant: Ellenberger & Poensgen GmbH, Altdorf (DE)

(72) Inventors: Manuel ENGEWALD, Nuernberg (DE); Fabian HIERETH, Lauterhofen (DE); Lothar HOFMEISTER, Neumarkt (DE); Hendrik-Christian KOEPF, Nuernberg (DE); Ricardo PIMENTA, Eckental (DE); Michael WATZLAWICK, Nuernberg (DE); Markus MIKLIS, Pfeifferhuette / Schwarzenbruck (DE)

(73) Assignee: Ellenberger & Poensgen GmbH, Altdorf (DE)

(21) Appl. No.: 18/082,170

(22) Filed: Dec. 15, 2022

(30) Foreign Application Priority Data
Dec. 17, 2021 (DE) 10 2021 214 610.4

(51) Int. Cl. H01H 73/04; H01H 71/24

(52) U.S. Cl. CPC H01H 73/045; H01H 71/2409; H01H 2231/026

(57) ABSTRACT

A circuit breaker having a mechanical switch which is inserted into a main current path and has a fixed contact and a moving contact which is connected to a contact bridge mounted movably thereto. The circuit breaker comprises a drive, which is operatively connected to the contact bridge, and a control unit, via which the drive is energized and which is powered from a control circuit. The drive has a “moving magnet actuator.”Further, a vehicle having the circuit breaker is provided.

This nonprovisional application claims priority under 35 U.S.C. § 119(a) to German Patent Application No. 10 2021 214 610.4, which was filed in Germany on Dec. 17, 2021, and which is herein incorporated by reference.

### BACKGROUND OF THE INVENTION

### Field of the Invention

The present invention relates to a circuit breaker having a mechanical switch inserted into a main current path. Further, the invention relates to a motor vehicle having a circuit breaker.

### Description of the Background Art

Motor vehicles such as commercial vehicles, therefore, buses or trucks, increasingly have one or more electric motors as their main drive, which is used directly for movement. To operate the electric motor(s), a high voltage battery is usually provided, via which a DC voltage between 400 V and 800 V is supplied. The electric currents conducted between the high voltage battery and the electric motor amount to several 10 A during operation.

In the event of a fault, such as a short circuit or an accident, it is necessary to disconnect the high voltage battery electrically from other components of the motor vehicle, such as the electric motor. A circuit breaker is usually used for this purpose, which has a switch inserted into a main current path between the high voltage battery and the electric motor. The circuit breaker is designed such that when the electric current carried by the main current path exceeds a certain limit value, the switch is actuated so that the electric current flow is stopped.

For example, a semiconductor switch is provided as the switch. However, relatively high electrical losses occur with this switch during operation, which reduces the efficiency and thus also the range of the motor vehicle. Alternatively, a (mechanical) relay is provided as the switch, which has a fixed contact and a moving contact which is movably mounted thereto. Due to the mechanical design, however, the circuit breaker has a relatively high inertia, so that the interruption of the electric current occurs only with a delay after the fault has been detected.

### SUMMARY OF THE INVENTION

It is therefore an object of the present invention to provide a particularly suitable circuit breaker and a particularly suitable motor vehicle, wherein advantageously safety is increased.

The circuit breaker is used in particular for protection, therefore, the safeguarding, of an electric line and/or a component such as a device. In other words, the circuit breaker thus is a miniature circuit breaker or a device circuit breaker.

The circuit breaker has a main current path into which a mechanical switch is inserted. During operation, an electric current is conducted via the main current path and/or an electrical voltage is applied to it, wherein in the event of a fault, therefore, when protection is required, the electric current flow via the main current path is to be interrupted in particular. Preferably, the main current path is formed at least partially via a bus bar made, for example, of a metal, preferably a copper, such as pure copper or a copper alloy, for example, brass. Expediently, the circuit breaker has at least two terminals via which the main current path is connected to further components in the assembled state. The terminals are, for example, structurally identical to one another or different and, for example, in each case a screw terminal or plug-in connection.

The mechanical switch, which is also referred to simply as a switch hereinafter, has a fixed contact and a moving contact which is connected to a contact bridge movably mounted with respect to the fixed contact. Consequently, the moving contact is also movably mounted relative to the fixed contact, namely, via the contact bridge. For example, the moving contact is welded to the contact bridge and is, for example, integral therewith. Alternatively, the moving contact is made of a material different from the contact bridge. For example, the fixed contact is held in place and its position is therefore rigid. Alternatively, the position of the fixed contact is also variable, and it is movably mounted, for example, via a further bridge or other mechanical conditions.

Preferably, the circuit breaker comprises a housing, which, for example, is made of a plastic, and within which both the fixed contact and the moving contact are arranged. In this case, the contact bridge is expediently mounted on the housing via a hinge or other bearing, for example, a plain bearing. In a refinement, a guide is formed via the housing itself, via which the contact bridge is mounted. The fixed contact is particularly preferably rigidly arranged on the housing or at least immovable with respect to the housing, which is why construction is simplified. For example, the contact bridge is mechanically connected directly to a rigid (possible) bus bar of the main current path and thus, in particular, to one of the possible terminals. For movable mounting, the contact bridge is expediently mounted in a pivotable manner.

The contact bridge can be formed via a stamped/bent part, or other metal strip, and is mounted so as to be transversely displaceable. A further moving contact is expediently connected to the contact bridge. The further moving contact is expediently associated with a further fixed contact, and when the contact bridge is moved, a mechanical contact between the moving contact and the fixed contact and between the further moving contact and the further fixed contact is suitably created or removed, in particular depending on the direction of movement of the contact bridge.

In summary, if there is mechanical contact between the moving contact and the fixed contact, the mechanical switch is closed and electrically conductive. If the moving contact is spaced apart from the fixed contact via the contact bridge, the switch is open and electrically nonconductive. Thus, depending on the position (state) of the contact bridge, the switch is either in the open or closed state or, for example, in a position in between. In this position, the distance between the moving contact and the fixed contact is not maximal, but there is no mechanical contact between them. For example, the switch comprises a lock or other latch by which the contact bridge is locked in the open or closed state. In other words, the switch is therefore designed monostable or bistable. Provided that the locking occurs in only one of the states, this is, for example, the closed or open state. Due to the locking/latching, it is necessary to apply a force to move the contact bridge, therefore, to actuate the switch, so that unintentional actuation of the (mechanical) switch, for example, due to a vibration of the circuit breaker, is excluded.

The circuit breaker further comprises a drive which is operatively connected to the contact bridge. By actuating the drive, it is possible to move the contact bridge from at least one of the two positions to the other, therefore, the closed or open position. In other words, it is possible to shift the switch by actuating the drive.

The circuit breaker further comprises a control unit via which the drive is energized. In particular, the control unit is designed here such that it detects the fault and that, in the event of a fault, the drive is energized or at least actuated in such a way that the switch is opened; therefore, the moving contact is spaced apart from the fixed contact. The control unit is suitable and provided and set up for this purpose. A control circuit, via which the control unit is thus powered, is provided for supplying the control unit. The control circuit is particularly preferably galvanically isolated from the main circuit, so that in the event of a fault in the main current path, a feedback effect on the control circuit is prevented. Thus, the supplying of current to the drive can occur essentially undisturbed. The control circuit is powered, for example, via the main current path, in particular via a transformer. In a refinement, the control circuit is powered via a separate energy source, and the circuit breaker has further connections for this purpose in particular, which are incorporated, for example, in the possible housing of the circuit breaker. Expediently, the control circuit has a voltage level that differs from the voltage level, or at least the electrical potential, carried by the main current path. In particular, the control circuit is operated with a lower electrical voltage. Thus, construction of the circuit breaker is simplified.

The drive comprises a so-called “moving magnet actuator.” The “moving magnet actuator” has a permanent magnet which is mounted movably. For example, the permanent magnet is rotatably mounted or, particularly preferably, linearly movable. The permanent magnet is attached to the contact bridge or at least operatively connected to it, so that when the permanent magnet moves, the contact bridge is preferably moved. In addition, the “moving magnet actuator” has a drive unit with one or more electric coils which are energized when the drive is actuated, so that a magnetic interaction takes place between them and the permanent magnet. The electric coils are held stationary in this case.

Because the electric coil(s) is/are held stationary, construction is simplified and, with the exception of the components required for the mounting, no other moving components or electrical connections are required between the moving components, namely, the permanent magnet, and the stationary components of the “moving magnet actuator”, which is also referred to hereinafter simply as the actuator. Thus, friction is also reduced.

Because the number of moving components of the “moving magnet actuator,” in particular only the permanent magnet, is relatively small, and these in particular have a relatively low weight, the dynamics of the actuator are relatively high. Thus, inertia is reduced when the contact bridge is actuated and thus when the switch is actuated. As a result, the circuit breaker enables relatively fast switching, which is why safety is increased. Due to the mechanical switch, the electrical resistance of the circuit breaker is relatively low, so that no or only relatively low electrical losses occur during operation of the circuit breaker. The circuit breaker also enables galvanic separation, which is why safety is increased further.

For example, the actuator is designed to be rotary or particularly preferably linear. In this case, the drive unit has two electric coils arranged concentrically on an axis and spaced apart from on another along the axis, and between which the permanent magnet is arranged, whose two poles are opposite one another with respect to the axis, and is mounted movably along the axis. In particular, the two electric coils are energized simultaneously and are, for example, electrically connected in series or, particularly preferably, electrically parallel to one another. The circuitry of the electric coils is such that when they are energized, a magnetic field is created via the electric coils which field interacts with the magnetic field of the permanent magnet in such a way that it is pulled along the axis towards one of the electric coils and pushed away from the other. Consequently, a relatively large force acts on the permanent magnet, which is why the dynamics are further increased.

The actuator also can have a (magnetic) short-circuit plate or the like via which the permanent magnet is held in a specific position when the electric coil(s) is (are) not energized. For example, in this case the permanent magnet is in contact with the short-circuit plate or, particularly preferably, is always spaced apart from it. The short-circuit plate is expediently made of a ferromagnetic material, such as iron, for example, which is why manufacturing costs are reduced. Due to the short-circuit plate, the permanent magnet is stabilized in one position, especially when the switch is closed. Consequently, the mechanical switch is designed at least monostable or bistable.

The circuit breaker can be used in a motor vehicle, especially in an on-board electrical system, via which an electrical DC current is conducted. Particularly preferably, the circuit breaker is a component of a high-voltage on-board electrical system of the motor vehicle and serves in particular to protect a high voltage battery and/or an electric motor of a motor vehicle, via which in particular a propulsion takes place. The motor vehicle is, for example, a ship, boat, or aircraft. Particularly preferably, however, the motor vehicle is land-based and, for example, rail-guided. The motor vehicle in this case is, for example, a railcar, locomotive, train, or streetcar. Alternatively, the motor vehicle can be moved independently of rails or the like. The motor vehicle is expediently a passenger car or, particularly preferably, a commercial vehicle, such as, for example, a bus or a truck. Alternatively, the circuit breaker is intended for the industrial sector and is, for example, a component of an industrial plant in the assembled state.

The circuit breaker can be designed for DC interruption and is, for example, only unidirectional or, particularly preferably, bidirectional. Suitably, the circuit breaker has a further main current path, wherein an electrical voltage is present between the main current path and the further main current path during operation. For example, the further main current path is electrically connected to ground, or the circuit breaker has a further mechanical switch which is inserted into the further main current path and which is actuated via a corresponding drive. Safety is thus increased further. Particularly preferred is a maximum electrical voltage greater than 100 V, 200 V, or 500 V which can be switched via the circuit breaker. For example, the maximum electrical voltage which can be switched via the circuit breaker is less than 3500 V or 3000 V. The circuit breaker is suitable, in particular provided and set up, for this purpose. For example, the circuit breaker is provided for switching an electrical voltage of 1000 V, and/or switching an electric current of multiple 100 A, therefore, for example, 200 A, 400 A, 600 A, or 800 A. The circuit breaker is expediently suitable, preferably set up, for this purpose in each case.

The control unit can be signal-connected to further components in the assembled state and expediently has a corresponding connection for this. For example, the control unit has a connection to any bus system of the possible motor vehicle. Suitably, the circuit breaker is used to provide functional safety, and the control unit is designed accordingly. In particular, it is possible hereby to realize various safety functions via the circuit breaker, and the control unit is certified accordingly, for example, or at least the various control modes for the drive are stored in it to provide functional safety. In a refinement, the control unit is used in particular to control and/or regulate the electric current for energizing the drive, wherein, for example, pulse width modulation is used. In this way, it is possible to set a switching time of the drive.

The circuit breaker can have a manual switch which is operatively connected to the mechanical switch, preferably to the contact bridge. Via the manual switch it is suitably possible to bring the mechanical switch into a specific state, for example, into the closed state or the open state. For example, bringing into the respective other state is not possible due to a mechanism located between the mechanical switch and the manual switch. Particularly preferably, however, it is possible to transfer the mechanical switch to both the closed and the open state via the manual switch. In summary, the circuit breaker is thus also manually operable, and it is thus possible in particular to reset the circuit breaker. Alternatively or in combination, it is possible, for example, via the circuit breaker to manually prevent operation, for example, of a possible motor vehicle.

The circuit breaker can comprise a further mechanism which acts on the mechanical switch and via which the mechanical switch can be reset. In particular, the drive or a further drive is provided for this purpose, which in particular is also controlled via the control unit. Thus, after the circuit breaker has tripped, resetting is also possible so that it is energized again. Expediently, no manual activity is required for this purpose.

The control unit can have, for example, a trigger, which is designed in particular in the manner of a switch. For example, the trigger is located in close proximity to or in mechanical contact with the main flow path or, for example, is a component of the main flow path. In particular, the electric current carried by the main current path and/or the electrical voltage applied thereto is detected via the trigger, and the drive is energized as a function of this. The trigger is, for example, of magnetic design and is, for example, a reed relay or at least comprises such a relay. Alternatively, the trigger is hydraulic or, particularly preferably, a thermal trigger, such as, for example, a bimetal snap disc, another bimetal element, a PTC thermistor, or an NTC thermistor.

For example, the control unit can be formed via the trigger, and the trigger is expediently electrically connected in series with the drive, preferably the electric coils of the actuator. Alternatively, the respective trigger is merely designed in the manner of a signal transmitter, and is signal-connected to further components of the control unit. The control unit itself is realized, for example, via analog components, or it has a microcontroller, for example.

The control unit can be signal-connected to a current sensor of the main current path. The current sensor is suitable, in particular provided and set up, for measuring the electric current conducted via the main current path. The control unit is realized in particular via a microcontroller, or at least comprises such a microcontroller, or has several discrete analog components. For example, the current sensor comprises an electric coil or, for example, a shunt inserted into the main current path.

Depending on the electric current value detected by the current sensor, the drive is expediently energized via the control unit, so that the contact bridge and consequently the mechanical switch are actuated. Due to such an embodiment, flexibility is increased in particular, and it is possible in particular to use the circuit breaker in different fields of application. Particularly preferably, the circuit breaker alternatively or in combination comprises at least one or more electrical voltage sensors, via which, for example, the electrical voltage dropping across the mechanical switch, the electrical voltage dropping across the possible current sensor, and/or the electrical voltage present between the main current path and the possible further main current path can be measured. Preferably, the drive is energized via the control unit depending on the values detected in each case. Suitably, the control unit evaluates the change in electric current or electrical voltage over time and actuates the drive as a function thereof. Consequently, detection of a wide range of fault cases is made possible, which is why safety is increased.

The control unit can comprise an energy storage device for energizing the drive. In particular, during operation the energy storage device is charged via the control circuit. Thus, the drive can be actuated even if the energizing via the control circuit fails, which is why safety is always guaranteed. Particularly preferably, the energy storage device can be designed as a capacitor, which is connected electrically in parallel to the drive or other components of the control unit, such as any possible microcontroller. The capacitor thus also compensates for any voltage fluctuations in the control circuit, which is why the drive and the other components of the control unit are protected and safe operation is made possible. In other words, short-term current jumps are damped via the capacitor.

For example, the control unit can comprise a charge pump, a voltage multiplier, or other component via which it is possible to charge the energy storage device to a higher electrical voltage than is provided via the control circuit. In this way, a relatively large amount of electrical energy is stored during operation via the energy storage device, so that in the event of a failure of the control circuit, further components of the control unit can also be energized, or an increased amount of electrical energy is provided for operating the drive, so that the mechanical switch is reliably actuated.

For example, the actuator can have only the one drive unit. Particularly preferably, however, the “moving magnet actuator” has two drive units, wherein one of which is formed, in particular, via the two electric coils, or at least comprises them; these are electrically connected in parallel or in series with one another. Suitably, the other drive unit also has two electric coils, which are also electrically connected in parallel or in series. Here, in particular, each of the electric coils of one of the drive units is surrounded in each case by one of the electric coils of the other drive units, and these are in particular arranged concentrically to one another. Thus, a relatively compact “moving magnet actuator” is provided. The two drive units can be energized separately here via the control unit and are suitably connected for this purpose. In particular, however, it is also possible to energize the two drive units simultaneously.

Via the two drive units, it is made possible to exert a relatively large force on the permanent magnet so that it is accelerated relatively greatly. As a result, a switching time of the mechanical switch is also accelerated, suitably in the event of a fault. However, it is also possible to actuate the mechanical switch with only one of the drive units, so that an electrical and also mechanical load as well as a power requirement are reduced. As a result, the field of application of the circuit breaker is increased, and it is used, for example, also during normal operation to interrupt the electric current, wherein only one of the drive units is energized. In the event of a fault, however, both drive units are used for actuating the switch. Thus, the number of required components is reduced.

For example, the contact bridge can be subjected to a force, for example, a spring force, and it is held in a specific position, for example, via a latch. Here, the drive acts on the latch in particular, so that the latch is released when the drive is energized. As a result, the contact bridge is moved due to the further acting force. As a result, it is not necessary to exert a relatively great force via the drive, wherein nevertheless a relatively rapid actuation of the mechanical switch occurs.

The drive can be mechanically coupled to the contact bridge, and in particular the permanent magnet is connected to the contact bridge via a mechanism. In other words, during operation the contact bridge is moved due to the force exerted via the drive. As a result, the number of required components is reduced. In a further refinement, the contact bridge is latched, and the drive acts on both the latch and the contact bridge. Expediently, a further component is present here via which a force is also exerted on the contact bridge, such as the spring, for example. In this way, the actuation of the mechanical switch, therefore, the moving of the contact bridge, takes place both via the drive and via the further component, such as the spring, so that a switching speed is further increased. In this regard, the force to be applied by the drive is reduced so that it can be designed to be relatively small. However, the force applied via the drive is also used to move the contact bridge, so that the force provided is used relatively efficiently.

For example, the contact bridge may be rigidly attached to a transversely mounted rod driven via the drive. Preferably, however, the contact bridge is also mounted transversely on the rod, wherein expediently there are two end stops for limiting the movement of the contact bridge with respect to the rod. It is thus possible to move the contact bridge between these two end stops, so that, for example, in the event of a possible contact burn-off or high manufacturing tolerances, there is still a secure, full-surface mechanical contact of the moving contact with the fixed contact clock in the closed state of the circuit breaker. In particular, one of the end stops is designed such that the contact bridge can still be moved out of the closed state via the drive. In other words, the distance between the end stops is preferably less than the travel of the drive. Due to the remaining end stop, it is also possible to move the contact bridge independently of the current state of the drive, so that the contact bridge is also lifted off in the event of a relatively high flowing electric current due to the so-called Holms' constriction force, so that the moving contact is separated from the fixed contact. This occurs, for example, even before the contact bridge is moved via the drive. In other words, both the force applied via the drive and the forces present due to the existing magnetic fields act on the contact bridge in this case, so that a switching speed is increased. Preferably, a spring is arranged between one of the end stops and the contact bridge, via which the contact bridge is moved into a specific position when no further forces are acting.

For example, the circuit breaker can be formed merely via the main current path, the mechanical switch, the control unit, and the drive. Particularly preferably, however, the circuit breaker comprises a fuse. For example, the fuse is electrically connected in series to the mechanical switch, and in particular is designed to trip when the mechanical switch malfunctions. Safety is increased in this way. Particularly preferably, however, the fuse is connected in parallel to the mechanical switch. If the mechanical switch is closed, electric current flows across it, and essentially no electrical voltage is present at the fuse. If the mechanical switch is actuated, therefore, when it is opened, the electric current commutates to the fuse so that no arc forms between the moving contact and the fixed contact. Due to the (electric) current flowing across the fuse, the fuse expediently trips, so that the flow of current across the fuse is interrupted. At this point in time, the moving contact is already suitably far enough away from the fixed contact due to the drive so that no more arcing occurs. As a result, the electric current flow across the circuit breaker is ended. In summary, a relatively safe interruption of the electric current takes place, wherein the formation of an arc across which electric current continues to be passed is prevented.

For example, the fuse can be designed in such a way that it can carry the electric current arising during normal operation, therefore, that the fuse does not trip in this case. Preferably, however, the fuse is dimensioned such that it trips when the switch is opened under normal conditions, therefore, when there is no fault. In this way, a switching behavior of the circuit breaker in the event of a fault is accelerated. In addition, it is possible in this way to use a relatively inexpensive fuse which is only designed for a low rated current and, in particular, is formed as a fast-acting fuse. Here, the actuation of the circuit breaker, therefore, the tripping, takes place via the control unit and the actuation of the drive, which can be set relatively precisely. The fuse is only used to conduct the electric current for a short time in order to prevent or at least shorten the formation of the arc at the mechanical switch. It is thus possible to also use fuses with a relatively high fault tolerance, which is why manufacturing costs are reduced. Due to the mechanical switch, a relatively precise setting of the circuit breaker is possible, therefore, when it trips.

Alternatively or in combination thereto, a semiconductor switch can be connected in parallel to the mechanical switch. In particular, a MOSFET, an IGBT, an IGCT, or GTO is used as the semiconductor switch. The semiconductor switch is fed, for example, via a separate voltage supply, for example, via the control circuit. Alternatively, the semiconductor switch is fed via the electrical voltage that drops across the (opened/opening) mechanical switch. In particular, in this case, the circuitry is such that the semiconductor switch carries current when the mechanical switch is opened, so that no arc forms at the mechanical switch. After the mechanical switch is opened, the semiconductor switch in particular is also opened so that the electric current is interrupted. In this case, the semiconductor switch is expediently not current-carrying during normal operation, therefore, when the mechanical switch is closed, so that no electrical losses occur in the semiconductor switch, which is why efficiency is improved. Preferably, a separate control unit is assigned to the semiconductor switch, or it is operated, for example, via the control unit via which the drive is also energized. Thus, the number of required components is reduced.

The circuit breaker can have a further semiconductor switch connected in series to the semiconductor switch, the mechanical switch being bridged via the series connection. In this regard, the two semiconductor switches are expediently connected anti-serially. Alternatively, the two semiconductor switches are connected anti-parallel. As a result, the circuit breaker can be operated bidirectionally. For example, the two semiconductor switches are structurally identical or different from one another. In a further alternative, instead of the further semiconductor switch, a diode is electrically connected in series to the semiconductor switch. In a refinement, the mechanical switch is bridged with a circuit having the semiconductor switch electrically connected between two pairs of two diodes in each case, each of which is connected anti-parallel to one another. In other words, a B4 bridge circuit is provided, via which a rectifier in particular is realized. It is ensured via the diodes that the direction of the current flow across the semiconductor switch is always the same, independent of the current flow direction via the main current path. Thus, the circuit breaker is designed bidirectional, wherein only the single semiconductor switch is present.

A varistor can be connected in parallel to the semiconductor switch(es) or the series circuit, said varistor via which in particular an electrical overvoltage at the semiconductor switch or circuit, which could lead to damage, is avoided. In a further alternative, the circuit breaker comprises a plurality of thyristors connected anti-parallel to one another and via which the mechanical switch is bridged.

The mechanical switch can comprise a quenching chamber, within which the contact bridge is expediently arranged. For example, the quenching chamber comprises a plurality of quenching plates and/or a permanent magnet, via which any arc generated between the moving contact and the fixed contact when the mechanical switch is actuated is extinguished.

The quenching chamber can comprise quenching strips stacked on top of one another in a stacking direction, therefore, a plurality of quenching strips, in particular at least two quenching strips and suitably less than 100 quenching strips. Preferably, the number of quenching strips is between 5 and 80, between 8 and 50, or between 10 and 30. Suitably, the number of quenching strips is less than or equal to 20. The quenching strips are designed to be planar and thus each extend in only one plane. Perpendicular to this plane, the extent of each quenching strip is reduced, and the extent, also referred to as thickness, is expediently less than or equal to 2 mm, 1.5 mm, or 1 mm. The quenching strips are expediently arranged perpendicular to the stacking direction and parallel to one another. Preferably, the projections of the quenching strips parallel to the stacking direction overlap at least partially, preferably completely. Thus, a relatively compact quenching chamber is provided.

The quenching strips can be made of a ceramic, which is in particular electrically nonconductive and preferably thermally conductive. Particularly preferably, an oxide ceramic is used as the ceramic, such as an aluminum oxide ceramic (AlO3). For example, the quenching chamber comprises a driving element for driving any arc generated during a switching operation of the mechanical switch to or between the quenching strips.

During operation, due to the design of the quenching strips as an electrical insulator, the arc is not captured partially via the quenching strips, so that a number of partial arcs are formed. Rather, due to the electrically insulating properties of the quenching strips, the arc is deformed, in particular bent, so that a length of the arc is extended. Due to the increased length of the arc and the resulting higher required electrical voltage, it is possible that the arc extinguishes. Thus, when the arc is extinguished, it has a length that can otherwise only be achieved with an enlarged quenching chamber.

In addition, the arc, namely, the plasma required to form the arc, is cooled via the quenching strips. As a result, the electrical voltage required to maintain the arc also increases, and with sufficient cooling, the arc is extinguished. Due to the thermal conductivity of the quenching strips, heat is efficiently removed from the area of the quenching strips where heat input from the arc into the respective quenching strip occurs. As a result, a cooling effect is further improved, so that even with a reduced size of the quenching chamber, a reliable quenching of the arc takes place. In addition, due to the separate quenching strips, any mechanical stress that develops as a result is limited to the individual quenching strips, even if these are heated irregularly. Therefore, even if there is a relatively large temperature difference between the individual quenching strips, no mechanical stress forms between them that could lead to destruction. As a result, stability and operational reliability are increased.

For example, the motor vehicle can be land-based and, for example, a passenger car. Particularly preferably, however, the motor vehicle is a commercial vehicle, such as a bus or, especially preferably, a truck. The motor vehicle has a high-voltage on-board electrical system via which in particular a DC voltage of between 400 V and 800 V is conducted. Further, the motor vehicle comprises a low-voltage on-board electrical system via which a DC voltage of 12 V, 24 V, or 48 V is expediently conducted. The low-voltage on-board electrical system is used in particular to supply power to the vehicle's auxiliary units, which can be used, for example, to provide comfort functions or the like. The high-voltage on-board electrical system is used in particular to supply power to a main drive, which expediently has an electric motor. Here, the main drive is preferably electrically connected via the high-voltage on-board electrical system to a high voltage battery, which supplies the high-voltage on-board electrical system. The low-voltage on-board electrical system is powered by the high-voltage on-board electrical system via a transformer, for example, or via a separate battery.

The motor vehicle can comprise a circuit breaker with a mechanical switch which is inserted into a main current path and which has a fixed contact and a moving contact connected to a contact bridge mounted movably thereto. The circuit breaker further has a drive, which is operatively connected to the contact bridge, and a control unit, via which the drive is energized, and which is powered from a control circuit. The drive comprises a “moving magnet actuator.”

The control circuit can be electrically connected to the low-voltage on-board electrical system and is thus powered via the low-voltage on-board electrical system. The high-voltage on-board electrical system has the main current path of the circuit breaker, which thus forms part of the high-voltage on-board electrical system and is incorporated into it. Consequently, the mechanical switch and the control unit are at different electrical potentials. When the circuit breaker is actuated, the high-voltage on-board electrical system is disconnected so that an electric current flow is at least partially prevented by it.

Further, the invention also relates to the use of a circuit breaker of this kind for protecting a high-voltage on-board electrical system of a motor vehicle.

The refinements and advantages explained in connection with the circuit breaker are analogously also to be applied to the vehicle and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows schematically a motor vehicle with a circuit breaker;

FIG. 2 is a simplified circuit diagram of the circuit breaker comprising a “moving magnet actuator”; and

FIG. 3 shows schematically the “moving magnet actuator” in a sectional view;

FIG. 4 shows an alternative embodiment of the circuit breaker according to FIG. 2; and

FIG. 5 shows perspectively a quenching chamber of the mechanical switch.

### DETAILED DESCRIPTION

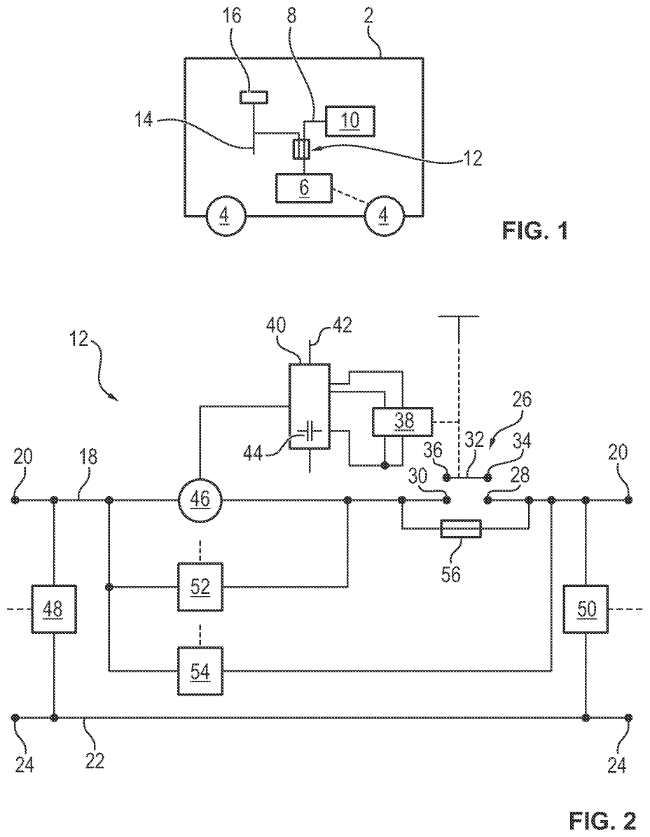

In FIG. 1, a motor vehicle 2 in the form of a truck is shown in a schematically simplified view. Motor vehicle 2 has a plurality of wheels 4 via which contact is made with a road surface which is not shown in more detail. At least one of wheels 4 is driven via a main drive 6 comprising one or more electric motors. In other words, motor vehicle 2 is designed as either a hybrid motor vehicle or an electric motor vehicle.

Main drive 6 is connected to a high voltage battery 10 via a high-voltage on-board electrical system 8. High voltage battery 10 is thus used to power the high-voltage on-board electrical system 8 and to operate main drive 6. An electrical DC voltage between 400 V and 800 V is provided by high voltage battery 10, wherein the electric currents flowing between high voltage battery 10 and main drive 6 can amount to several 10 A. Further, the high-voltage on-board electrical system 8 is connected to a charging port, so that high voltage battery 10 can be charged via the charging connection and high-voltage on-board electrical system 8.

A circuit breaker 12 is inserted into high-voltage on-board electrical system 8, via which high-voltage on-board electrical system 8 is protected. In this case, it is possible to prevent an electric current flow between high voltage battery 10 and main drive 6 via circuit breaker 12. Circuit breaker 12 hereby trips in the event of a fault, so that in the event of a fault, for example, in the event of damage to main drive 6, further damage or uncontrolled behavior of main drive 6 and also a danger to occupants or passers-by are avoided. Further, circuit breaker 12 is signal-connected to an on-board computer, via which safe functions are carried out with the involvement of circuit breaker 12 or requests to carry out safe functions are transmitted to circuit breaker 12, which are subsequently carried out at least partially by the latter. Consequently, circuit breaker 12 also serves to provide functional safety.

Circuit breaker 12 is further electrically connected to a low-voltage on-board electrical system 14, which is powered via a battery 16. Battery 16 provides a DC voltage of 24 V during operation, and low-voltage on-board electrical system 14 is used to supply power to auxiliary units which are used to operate main drive 6 and/or to provide comfort functions.

A simplified circuit diagram of circuit breaker 12 is shown in FIG. 2. Circuit breaker 12 has a main current path 18 extending between two terminals 20. The two terminals 20 are screw terminals or plug-in connections here and are placed in a housing of circuit breaker 12, which is made of a plastic. Circuit breaker 12 further has a further main current path 22 extending between two further terminals 24, which are structurally identical to terminals 20. Main current path 18 and further main current path 22 form a part of the high-voltage on-board electrical system 8, which thus has main current path 18. For this purpose, terminals 20 and further terminals 24 are electrically contacted with suitable cables or other lines of high-voltage on-board electrical system 8.

The further main current path 22 is created simply via a bus bar, which is made of a metal, such as copper or brass. The further main current path 22 is connected to ground via further terminals 24, and during normal operation of motor vehicle 2, the electrical DC voltage provided via high voltage battery 10 is present between main current path 18 and further main current path 22. In other words, main current path 18 and further main current path 22 are assigned to different poles of high voltage battery 10.

A mechanical switch 26 is inserted into main current path 18; it thus connects the two terminals 20 and is designed as a double interrupter. For this purpose, mechanical switch 26 has a fixed contact 28 and a further fixed contact 30, each of which is rigidly connected to one of the terminals 20 via a rigid bus bar and are spaced apart from one another. The two fixed contacts 28, 30 are made of a material which differs from the material of the associated bus bars and which, in particular, is relatively fire-resistant.

Mechanical switch 26 further comprises a contact bridge 32 formed via a further bus bar which is longitudinally displaceable, therefore, movable, via a guide of the housing of circuit breaker 12. A moving contact 34 and a further moving contact 36 are attached, namely welded, to opposite ends of contact bridge 32, wherein the material of moving contacts 34, 36 corresponds to the material of fixed contacts 28, 30.

By displacing contact bridge 32, it is possible to bring moving contact 34 into direct mechanical contact with fixed contact 28 and further moving contact 36 into direct mechanical contact with further fixed contact 30, so that they are each electrically conductively connected. As a result, there is a low-resistance electrical connection between the two terminals 20, and mechanical switch 26 is electrically conductive. In other words, switch 26 is closed. Further, it is possible to space apart the respective contacts 28, 30, 34, 36 from one another by moving contact bridge 32. In this case, mechanical switch 26 is not electrically conductive and thus open.

Contact bridge 32 is driven via a drive 38, so that when drive 38 is operated, contact bridge 32 is moved and thus mechanical switch 26 is closed or opened. Consequently, drive 38 is operatively connected to contact bridge 32, namely, mechanically coupled thereto. Drive 38 is energized by a control unit 40, which is connected electrically to drive 38 for this purpose. For energizing control unit 40 and consequently drive 38, control unit 40 is electrically contacted with a control circuit 42, via which a DC voltage is provided. Control circuit 42 is in direct electrical contact with the low-voltage on-board electrical system 14, so that the DC voltage of 24 V is also conducted via control circuit 42.

Control unit 40 includes an energy storage device 44 in the form of a capacitor, which is charged via control circuit 42, and which is electrically connected in parallel to a microcontroller of control unit 40. Thus, via energy storage device 44, fluctuations in the electrical voltage and/or the electric current of the low-voltage on-board electrical system 14 are intercepted, so that damage to the microcontroller is avoided hereby. Also, because of energy storage device 44, it is possible to actuate drive 38 at least once in the event of a failure of the low-voltage on-board electrical system 14 and to open switch 26 in this way.

In a variant shown in more detail, control unit 40 also has a charge pump via which it is possible to increase the electrical voltage applied to capacitor 44 compared to the electrical voltage provided via low-voltage on-board electrical system 14, so that the amount of energy stored via energy storage device 44 is increased. Thus, a safe operation of drive 38 is always possible, even if there is a complete failure of low-voltage on-board electrical system 14 or if drive 38 is slightly blocked.

The energizing of drive 38 is set in this regard via the microcontroller, and it is signal-connected to a current sensor 46 of main current path 18. Current sensor 46 is inserted into main current path 18 and is configured as a shunt. Thus, measuring the electric current carried by main current path 18 is enabled by current sensor 46. Further, circuit breaker 12 has a first voltage sensor 48 via which the electrical voltage present between one of the terminals 20 and one of the other terminals 24 can be measured. The electrical voltage present between the remaining terminal 20 and the remaining further terminal 24 can be measured via a second voltage sensor 50. The electrical voltage dropping across current sensor 46 is measurable via a third voltage sensor 52, and the electrical voltage dropping across the series connection comprising current sensor 46 and mechanical switch 26 is measurable via a fourth voltage sensor 54. All voltage sensors 48, 50, 52, 54 are signal-connected to control unit 40, namely, the microcontroller.

During operation, the microcontroller of control unit 40 checks the change over time of the electrical voltages measured via voltage sensors 48, 50 52, 54 and the electric current measured via current sensor 46. If the change over time of the measured current corresponds to an increase and exceeds a certain limit value, drive 38 is activated via control unit 40 so that switch 26 is opened. The limit value is selected such that it is only exceeded in the event of a fault, namely, in the case of an electrical short circuit of the electric motor of main drive 6. Due to the actuation of mechanical switch 26, the electric current is interrupted and thus further destruction of the electric motor or further components of main drive 6 is avoided. Similarly, actuation of mechanical switch 26 via control unit 40 occurs when the electrical voltage detected via voltage sensors 48, 50, 52, 54 is used to conclude that a fault has occurred, such as a malfunction of certain components of motor vehicle 2.

If mechanical switch 26 is opened and the fault exists, a relatively high electrical voltage is present between terminals 20 during the opening of switch 26. As a result, an arc is formed in each case between fixed contacts 28, 30 and the associated moving contact 34, 36, each of which is moving away, and current continues to flow across the arc. However, the electrical voltage dropping across mechanical switch 26 increases. As a result, electric current commutates from electrical switch 26 to a fuse 56 connected in parallel therewith. Thus, the electric current between the two terminals 20 flows through fuse 56, which is why the arcs are quenched. Fuse 56 is dimensioned to trip in the event of a fault.

The threshold at which fuse 56 is tripped is between the value of the electric current in normal operation and the value of the electric current resulting from a short circuit, wherein the exact value of the threshold in between can be chosen arbitrarily without changing the functioning of circuit breaker 12. Thus, the error tolerances for fuse 56 can be selected to be relatively large, which is why manufacturing costs are reduced. After fuse 56 has been tripped, it can also no longer conduct electric current, and the two terminals 20 are galvanically isolated from one another.

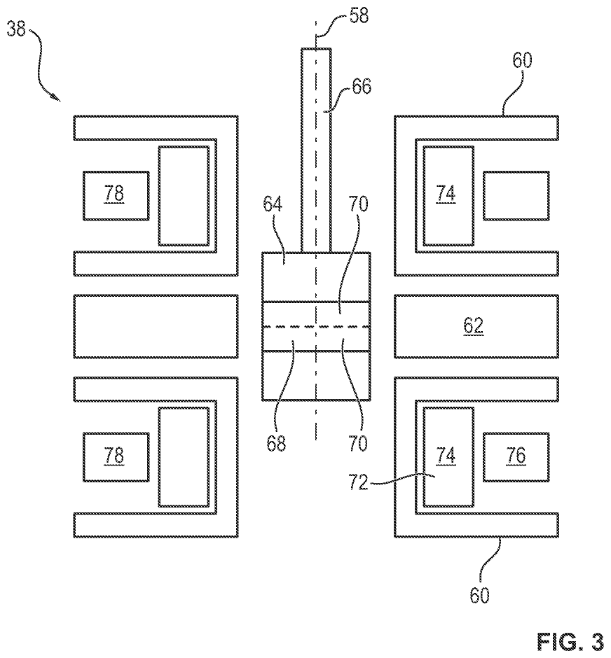

In FIG. 3, drive 38 is shown schematically in a sectional view along an axis 58. Drive 38 is configured as a “moving magnet actuator” and thus has two disc coil or drum type holders 60, which are concentric with and spaced along axis 58 and which are made from a ferromagnetic material. Positioned between these is an annular short-circuit plate 62 which is concentric with axis 58 and is also made from a ferromagnetic material. Via holders 60 and short-circuit plate 62, a hollow cylinder is thus formed, within which a further holder 64 made of a plastic is arranged and is mounted so as to be displaceable along axis 58 via a guide. Attached to holder 64 is a rod 66 which extends along axis 58 and is attached to contact bridge 32, either directly or via a mechanism. Embedded in the cylinder-like further holder 64 is a cylinder-shaped permanent magnet 68 having two magnetic poles 70, each of which forms one of the ends of permanent magnet 68 in a direction parallel to axis 58.

Further, drive 38 includes a drive unit 72 comprising two electric coils 74. Each of the electric coils 74, which are structurally identical to one another, is wound on one of the holders 60, and these are electrically connected in parallel to one another. Drive 38 includes another drive unit 76 comprising two additional electric coils 78, one of which is wound on one of the electric coils 74 and the other of which is wound on the remaining electric coil 74. The two other electric coils 78 are also connected electrically in parallel to one another. The two drive units 72, 76 are electrically contacted separately with control unit 40 at least on one side, so that it is possible to energize the two drive units 72, 76 separately via control unit 40.

When drive units 72, 76 are not energized, the magnetic interaction with short-circuit plate 62 as well as holders 60 pulls permanent magnet 68 into a position substantially within short-circuit plate 62, wherein a force of approximately 30 N acts on the permanent magnet 68 and thus also on further holder 64. Short-circuit bridge 32 is thus also held in the desired position with this force, namely, in the position in which mechanical switch 26 is closed.

In the event of a fault, both drive units 72, 76 are energized so that permanent magnet 68 is pushed away from one of the holders 60 along axis 58 due to the additional magnetic fields created and is pulled towards the remaining holder 60. Thus, relatively large forces act on permanent magnet 68 and consequently also on contact bridge 32 via the further holder 64 and rod 66, so that mechanical switch 26 is opened relatively quickly.

If the fault is not present and, for example, only the energizing of main drive 6 is to be interrupted, for example, for maintenance, only drive unit 72 is energized via control unit 40 so that switch 26 is opened relatively slowly. As a result, an electrical load and also a mechanical load on circuit breaker 12 are reduced. In this case, because the applied electrical voltage between terminals 20 is limited, fuse 56 does not trip and circuit breaker 12 can be returned to the electrically conductive state, for example, after maintenance has ended. For this purpose, for example, drive unit 72 is energized in the opposite direction or the energizing is terminated so that permanent magnet 68 is again pulled to short-circuit plate 62.

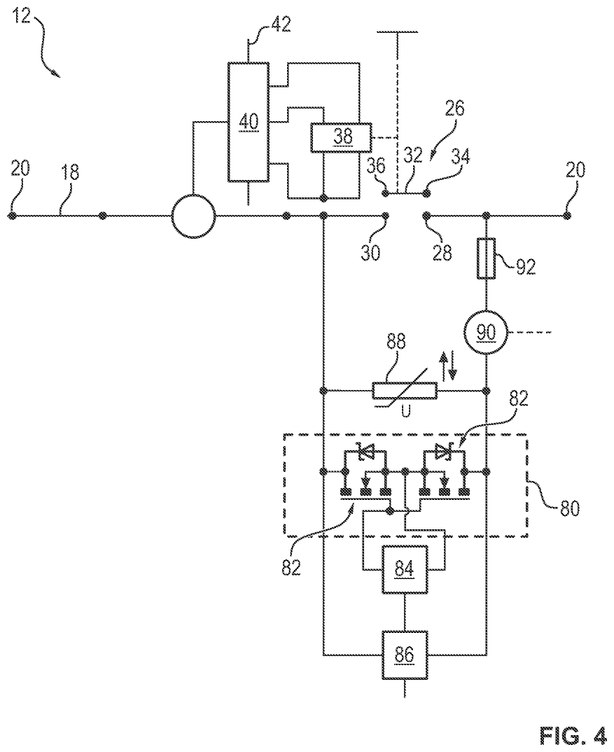

An alternative embodiment of circuit breaker 12 is shown schematically simplified in FIG. 4, wherein some components, such as main current path 22 and voltage sensors 48, 50, 52, 54, are not shown. However, these are also present but can also be omitted, as is also the case with the previous embodiment, as can energy storage device 44. Also, drive 38 and mechanical switch 26 are not modified.

However, fuse 56 is replaced by a switch group 80, via which mechanical switch 26 is thus bridged. Switch group 80 comprises two semiconductor switches 82 that are anti-serially connected to one another. Consequently, the two semiconductor switches 82 are connected in parallel to mechanical switch 26. The two semiconductor switches 82 are operated via a further control unit 84 and are placed via the latter into either the electrically conductive or electrically nonconductive state. Energizing of the further control unit 84 occurs via a further voltage supply 86, which is powered either via an electrical voltage dropping across mechanical switch 26 or via control circuit 42.

A surge protector 88, which in the illustrated variant is a varistor, is connected in parallel to switch group 80. In a variant not shown in more detail, surge protector 88 is realized using Zener diodes, TVS diodes, an RCD circuit, a controllable resistive load, or a combination thereof. Via surge protector 88, an electrical overvoltage at switch group 80 as well as the further control unit 84 and the further voltage supply 86 is avoided, which could otherwise lead to destruction thereof. Further, another current sensor 90 and another fuse 92 are electrically connected in series between main current path 18 and switch group 80.

In this example of the circuit breaker 12, semiconductor switches 82 are electrically nonconductive as long as mechanical switch 26 is closed.

When switch 26 is opened, the electrical voltage across switch assembly 80 increases so that the further voltage supply 86 is operated and therefore the further control unit 84 is energized. Switch group 80, namely, the individual semiconductor switches 82, is activated via further control unit 84, so that they become current-carrying. As a result, the electric current commutates and is conducted via switch group 80. Therefore, the arcs formed between fixed contacts 28, 30 and the respective moving contacts 34, 36 are quenched. Subsequently, semiconductor switches 82 are electrically controlled in such a way that they electrically block, so that the electric current flow between the two terminals 20 is terminated.

It is ensured until then via surge protector 88 that no overload of semiconductor switches 82 occurs. If it is detected via the further current sensor 90, which is signal-connected to the further control unit 84, that a relatively large electric current is carried by switch group 80, which could lead to damage of semiconductor switches 82, semiconductor switches 82 are also opened and thus damage to switch group 80 is avoided. It is thereby ensured via the further fuse 92 that even in the event of a malfunction of the further control unit 84 as well as in the event of a relatively high electric current, the current flow across switch group 80 is interrupted.

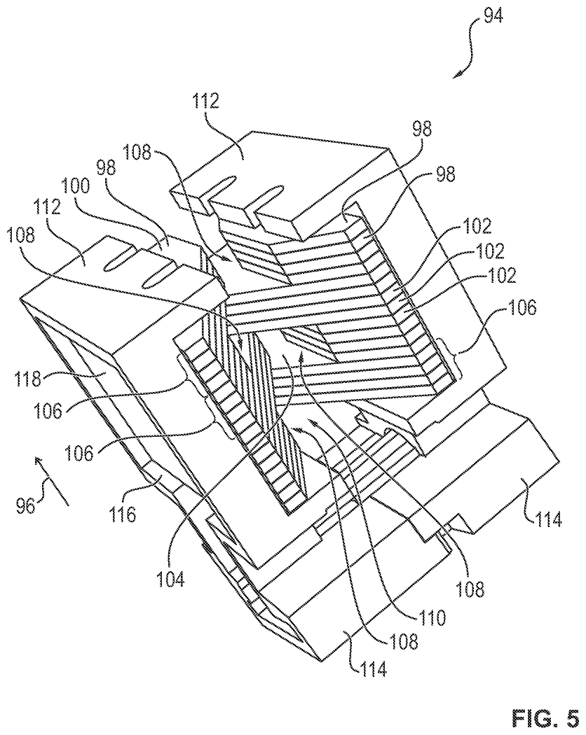

A perspective view of a quenching chamber 94 of mechanical switch 26 is shown in FIG. 5. Quenching chamber 94 is used hereby to quench an arc generated during a switching operation of mechanical switch 26, unless the other components present are used for this purpose. Quenching chamber 94 has a plurality of quenching strips 98 stacked on top of another in a stacking direction 96. Quenching strips 98 are made of an aluminum oxide ceramic and are designed flat and arranged perpendicular to stacking direction 96. The thickness of quenching strips 98, therefore, their extent in the stacking direction 96, is between 1 mm and 2 mm. Quenching strips 98 are directly adjacent to one another so that a stack 100 is formed. In this regard, stack 100 has a plurality of layers 102 arranged one on top of another in the stacking direction 96, which are thus arranged perpendicular to the stacking direction 96.

Two of quenching strips 98 are associated with each of the layers 102. The two quenching strips 98 of each layer 102 are hereby different from one another, and one of quenching strips 98 is formed wedge-shaped and the remaining one is trapezoidal. In other words, quenching strips 98 associated with each of the layers 102 differ, wherein, however, the same quenching strips 98, therefore, of the same type, are associated with each layer 102. In other words, quenching chamber 94 has two different types of quenching strips 98, namely, the wedge-shaped and the trapezoidal ones, and these are evenly distributed among layers 102.

The two quenching strips 98 of each layer 102 are spaced apart from one another perpendicular to stacking direction 96 so that a slot 104 is formed between them. Four of the layers 102 in each case are combined into a group 106, wherein quenching strips 98 of each group 106 are arranged flush with one another. Quenching strips 98 of the respective adjacent group 106, in contrast, are arranged in a mirror-inverted manner, so that stack 100 has a plurality of chambers 108 which lie one above the other in the stacking direction 96 and are separated from one another and each of which is formed via the mutually aligned slots 104. Due to the wedge or trapezoidal shape, a notch 110 is formed in each of the layers 102 and merges into the respective chambers 108. There are four such groups 106 in all.

Stack 100 is encompassed on both sides by a holder 112 in each case and is thus stabilized. Holders 112 are mirror images of each other and are made of a plastic material, and each has a base 114. The two holders 112 are attached to one another at the respective base 114, so that stack 100 is frictionally held between the two holders 112 both in the stacking direction 96 and perpendicular thereto. On the side opposite stack 100, each of the holders 112 has a rectangular pot- or pan-shaped receptacle 116 within each of which, in the assembled state, a permanent magnet 118 lies, each of which forms a driving element.

Quenching chamber 94 is oriented with respect to fixed contact 28, 30 as well as to moving contact 34, 36 such that an arc generated when mechanical switch 26 is actuated, therefore, when drive 38 is actuated, strikes stack 100 in the region of notches 110. Due to the interaction between the magnetic field of permanent magnets 118 and the magnetic field created by the arc, the arc is driven further into stack 100, namely, into the individual chambers 108. Thus, subsections of the arc are formed in the respective chambers 108, said subsections being U-shaped. The subsections are connected to one another, wherein the connecting sections encompass stack 100 on the side of notches 110. Consequently, the arc has a relatively long length. Due to notches 110, it is not possible for the arc to bypass quenching chamber 94. Due to the increase in the length of the arc, an electrical voltage required to sustain it increases.

Further, heat input from the plasma forming the arc into the individual quenching strips 98 occurs, so that the arc is cooled. Due to the ceramic used, the heat is dissipated relatively effectively and the arc is thus cooled. Because of the cooling, the electrical voltage required to maintain the arc also increases. Because the individual quenching strips 98 are separate from one another, no excessive mechanical stress is formed in stack 100 hereby, even if the individual quenching strips 98 are heated unevenly, which could lead to destruction.

The invention is not limited to the exemplary embodiments described above. Rather, other variants of the invention can also be derived herefrom by the skilled artisan, without going beyond the subject of the invention. Particularly, further all individual features described in relation to the individual exemplary embodiments can also be combined with one another in a different manner, without going beyond the subject of the invention.

What is claimed is:

1. A circuit breaker comprising:
a mechanical switch that is inserted into a main current path and has a fixed contact and a moving contact that is connected to a contact bridge mounted movably thereto;
a drive operatively connected to the contact bridge; and
a control unit, via which the drive is energized and which is powered from a control circuit,
wherein the drive comprises a moving magnet actuator.

2. The circuit breaker according to claim 1, wherein the control unit is signal-connected to a current sensor of the main current path.

3. The circuit breaker according to claim 1, wherein the control unit has an energy storage device for energizing the drive.

4. The circuit breaker according to claim 1, wherein the moving magnet actuator has two drive units, which can be energized separately via the control unit.

5. The circuit breaker according to claim 1, wherein the drive is mechanically coupled to the contact bridge.

6. The circuit breaker according to claim 1, wherein a fuse is connected in parallel to the mechanical switch.

7. The circuit breaker according to claim 1, wherein a semiconductor switch is connected in parallel to the mechanical switch.

8. The circuit breaker according to claim 1, wherein the mechanical switch has a quenching chamber comprising a plurality of flat quenching strips arranged parallel to one another and stacked on top of one another in a stacking direction, the quenching strips being made of a ceramic.

9. A motor vehicle comprising:
a high-voltage on-board electrical system;
a low-voltage on-board electrical system; and
a circuit breaker according to claim 1,
wherein the control circuit is electrically connected to the low-voltage on-board electrical system, and
wherein the high-voltage on-board electrical system has the main current path.
